(19) United States
(12) Patent Application Publication
(10) Pub. No.: US 2007/0004333 A1
(43) Pub. Date: Jan. 4, 2007

(54) Broadcast messaging in a telecommunication network

(76) Inventor: Mika Kavanti, Naantali (FI)

Correspondence Address: BANNER & WITCOFF, 1001 G STREET N W, SUITE 1100, WASHINGTON, DC, 20001, US

(21) Appl. No.: 10/543,921

(22) PCT Filed: Feb. 28, 2003
(86) PCT No.: PCT/IB03/00772

§ 371 Date: May 3, 2006

(51) Int. Cl. H04H 7/00

(52) U.S. Cl. 455/3.06

(57) ABSTRACT

A method for transmission of a data message from a message center to a receiving mobile station in a telecommunication network is disclosed. The method comprises the steps of: Providing a data message to be forwarded to said receiving mobile station; Incorporating identification information for identification of said receiving mobile station in said data message; Storing the message in a server; Making a query to check the receiving mobile station location area and availability in the server; Broadcasting said data message in a geographical area in which said receiving mobile station is situated; and Acknowledging reception of the data message at the receiving mobile station to the message center through the telecommunication network. Further, a corresponding mobile station and telecommunications system is disclosed.

### FIELD OF THE INVENTION

The present invention relates to a method for transmission of a data message from a message center to a receiving mobile station in a telecommunication network. Further, the invention relates to a corresponding apparatus and mobile station.

### BACKGROUND OF THE INVENTION

In telecommunication networks, mobile stations, such as portable telephones, can be used for making and receiving telephone calls, sending and receiving messages, and even browsing world-wide computer network such as the Internet. Many standards exist for mobile telephones, including the global system for mobile communications (GSM), the general radio packet service (GPRS). Receivers capable of receiving digital television signals, such as signals according to the terrestrial digital video broadcasting (DVB-T) standard are also commonplace.

For receiving and transmitting data messages the telecommunication network is used, and e.g. the short message service (SMS) standard is conventionally used. However, a problem with this conventionally used solution is that the telecommunication network, such as GSM, GPRS, UMTS, has a limited and scarce transmission capacity. Thus, when e.g. a SMS is sent over the network, it uses this scarce signaling capacity, and thereby reduces is even further for the other applications, such as voice or data calls. Further, the base stations are often forced to page the mobile telephones in relative large areas. Still further, it is often necessary to resend the messages from the messaging center, which uses even more of the capacity in the network.

In the future it can be expected that the size of the messages are growing, like the Multimedia Messages are already shown. These larger messages will increase the usage of the cellular network resources even further.

### SUMMARY OF THE INVENTION

It is therefore an object of the present invention to provide a method and an apparatus for more capacity efficient data messaging.

This object is achieved with a method and apparatus according to the appended claims.

According to a first aspect of the invention, it is provided a method for transmission of a data message from a message center to a receiving mobile station in a telecommunication network. The method comprises the steps of:

providing a data message to be forwarded to said receiving mobile station;

incorporating identification information for identification of said receiving mobile station in said data message;

storing the message in a server;

making a query to check the receiving mobile station location area and availability in the server;

broadcasting said data message in a geographical area in which said receiving mobile station is situated; and

acknowledging reception of the data message at the receiving mobile station to the message center through the telecommunication network.

With the data message transmission according to the invention, there is no need to use the scarce signaling and point-to-point messaging capacity in the network for data messages and that capacity could instead be saved for voice or data calls. Further, when messaging is done over the telecommunication network the base stations are normally forced to page the mobile station in relative large areas. Still further, resending of messages in telecommunication networks uses a significant amount of capacity in the network. With the present invention, this capacity use is held at a minimum, since the need for extra signaling and paging for resending of messages is alleviated.

The inventive way of sending messages over the air could be used for many types of data message transmission, such as for SMS messaging, Cell Broadcasting and also in Multimedia Messaging, e.g. for sending WAP Push indications over SMS or sending Multimedia Messaging-based information, like advertising in large geographical areas.

Broadcasting networks could also comprise very high messaging capacity compared to telecommunication networks.

In a preferred embodiment, the data message is broadcasted through Digital Video Broadcasting-Terrestrial (DVB-T) datacast. The DVB-T Datacast is a very efficient way for broadcast transmission of messages over the air in comparison to e.g. GSM, GPRS and UMTS solutions, and has a very high messaging capacity.

It is further preferred that the data message is a Short Message Service (SMS) message or Multimedia Message (MMS). In that case, the data message to be forwarded could be an SMS or MMS message from another remote terminal in said telecommunication network or from external application connected through API to Datacast Messaging Center (DMC).

The geographical area in which the receiving mobile station is situated could preferably be identified by means of a location register, e.g. Home Location Register (HLR) of said telecommunication network.

In a preferred embodiment, the identification information incorporated into the data message comprises a Mobile Subscriber ISDN number (MSISDN) for said user in said telecommunication network or some other identifier, such as an IP-address.

Still further, the step of broadcasting said data message could be repeated until a predetermined condition is reached. The predetermined condition is preferably at least one of: reception of the acknowledgement from the receiving mobile station and reaching a predetermined maximum resending time.

According to another aspect of the present invention, it relates to a corresponding apparatus for transmission of a data message from a message center to a receiving mobile station in a telecommunication network. The apparatus comprises:

receiving means for reception of a data message to be forwarded to said receiving mobile station;

means for incorporating identification information for said receiving mobile station to said data message;

a broadcasting device for broadcasting said data message in a geographical area in which said receiving mobile station is situated; and

acknowledging reception means for reception of an acknowledgement from the receiving mobile station through the telecommunication network.

Preferably, it also comprises interfaces to connect the apparatus to various networks, like e.g. telecommunications networks, IP-networks, short message service centers and multimedia message centers.

According to still another aspect of the invention, a mobile station for a telecommunication network is provided, comprising:

bi-directional communication means for communication through said telecommunication network;

broadcast receiving means for receiving broadcasting information;

filtering means for identifying a receiving a data message received by said broadcast receiving means if said message comprises identification information for said receiving mobile station; and

means for acknowledging reception of a data message through said bi-directional communication means.

According to still another aspect, the invention relates to a telecommunications system incorporating an apparatus as discussed above.

### BRIEF DESCRIPTION OF THE DRAWINGS

For exemplifying purposes, the invention will be described in closer detail in the following with reference to embodiments thereof illustrated in the attached drawings, wherein:

FIG. 1 is a mobile station according to an embodiment of the invention, e.g. to be used in the telecommunication network of FIG. 4;

FIG. 2 is a computer server based system to be used in the telecommunications network of FIG. 4; and

FIG. 3 is a flow chart illustrating a method according to an embodiment of the present invention; and

FIG. 4 is a schematic block diagram illustrating a telecommunication network according to one embodiment of the present invention.

### DESCRIPTION OF PREFERRED EMBODIMENTS

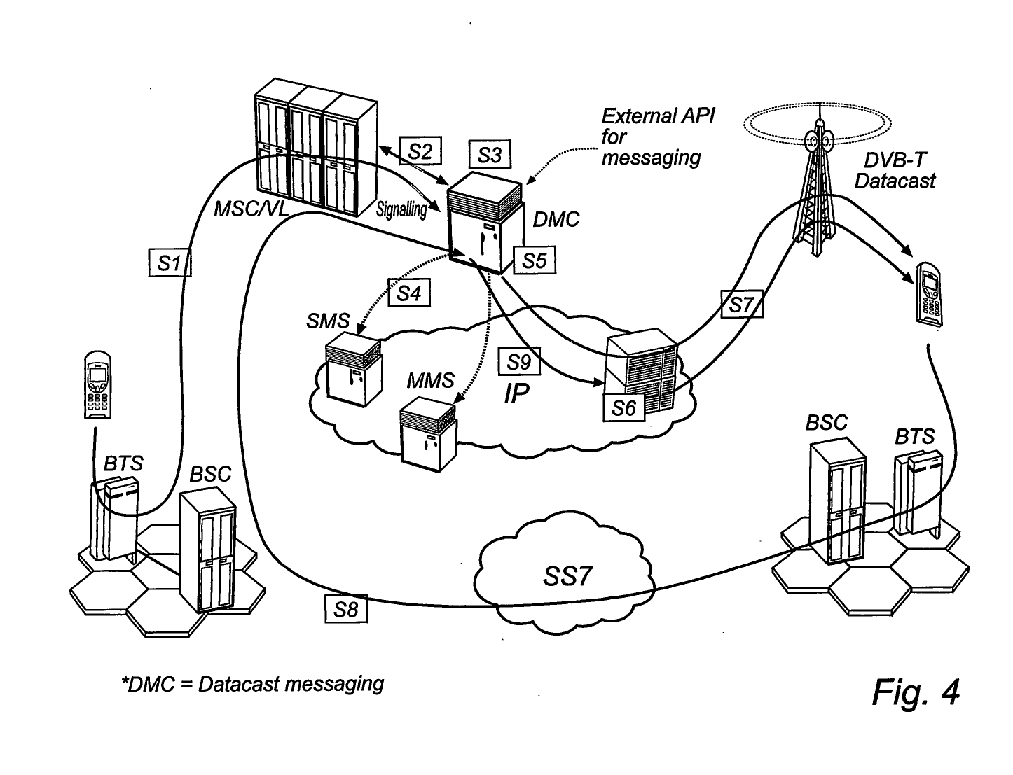

Referring to FIG. 4, a telecommunication system comprises at least one mobile station 1, such as a mobile phone, connected through a telecommunication network. The telecommunication network could be using any of the available standards, such as GSM, GPRS or UMTS. Data messages could be transmitted through the telecommunication network, e.g. with the SMS standard.

The telecommunication system further comprises a broadcasting network, and preferably a DVB-T network. In the inventive system, the DVB-T network could be used for IP Datacast for efficient delivery of data messages to the mobile stations. To this end, the mobile stations are equipped with broadcast transmission receivers, such as DVB-T Datacast receivers, as will be discussed more thoroughly in the following. Hereby, the data messages could be delivered same time into air like a stream. The geographical area in which the mobile station is situated could be located with a location register, e.g. Home Location Register (HLR) of the telecommunication network. Accordingly, the message need only be broadcasted in this geographical area. However, alternatively it is possible to broadcast the message in larger geographical areas or in several different geographical areas simultaneously. In that case, the specific location of the receiving mobile station need not be known.

The message to be transmitted to the receiving mobile station is provided to a message center in the network. This message center can be included in the telecommunication network, e.g. as a feature in the Short Messaging Service Center (SMSC), Multimedia Messaging Service Center (MMSC) or it can be a separated Datacast Messaging Center (DMC).

The data message to be transmitted could be a Short Message Service (SMS) message or a Multimedia Message with richer content. In that case, the data message to be forwarded could be a conventional SMS message received from another remote terminal, such as another mobile station, in said telecommunication network.

Before broadcasting of the message, identification information for identification of said receiving mobile station is incorporated in said data message. This could be made by adding a header to the message comprising the identification information. E.g. the identification information could comprise a Mobile Subscriber ISDN number (MSISDN) for said user in said telecommunication network or individual IP-address of the terminal. The receiving mobile station filters the received broadcast messages, and filters out the messages addressed to the mobile station based on the identification information.

When a mobile station has received a broadcast message it sends an acknowledgement back to Messaging Center through the telecommunication network. This could be done in a conventional fashion, as presently in a GSM network.

By using a broadcast network for the data message transmission, the data rate and transmission capacity could be increased greatly. For example, if DVB-T is used, the capacity of can be calculated as follows: One multiplexer can deliver a DVB-T transport stream suitable for mobile reception, which has a capacity of 12 Mbit/s. The length of one SMS is normally 140 bytes and there will be some overhead, so the total length could be estimated to be about 200 bytes. Then it would be possible to deliver 12.000.000/8/200=7.500 SMS/s.

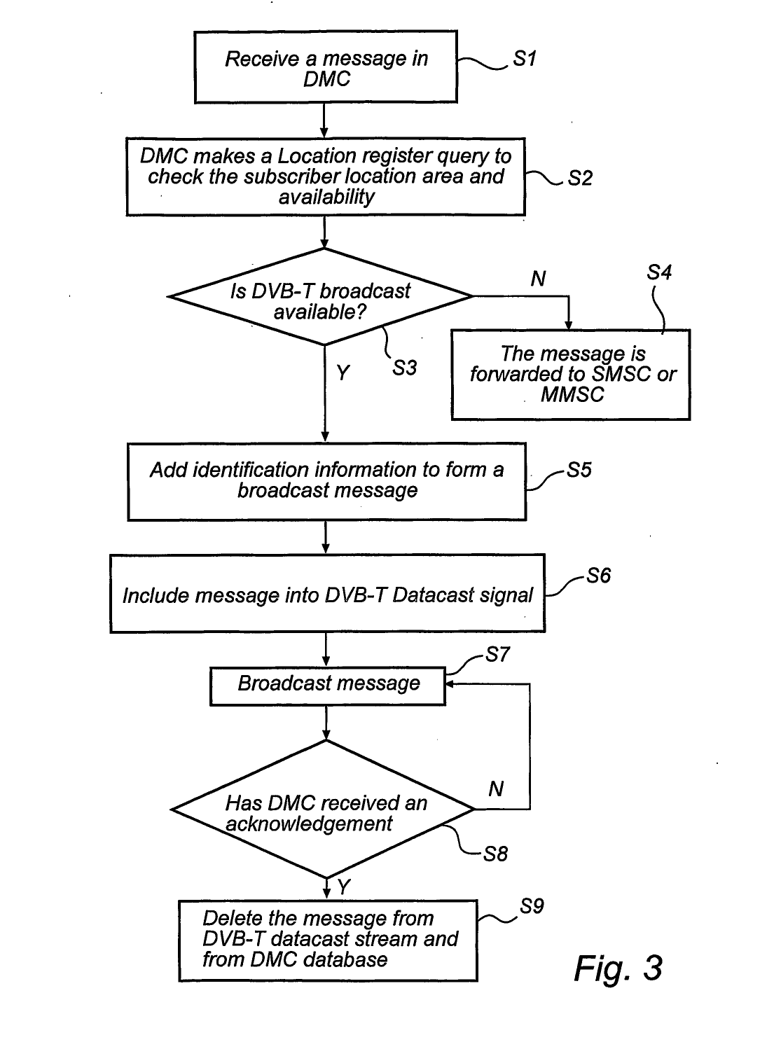

With reference to FIGS. 3 and 4, a message flow over the network elements as generally discussed before will now be discussed in more detail.

In a first step S1 the message is received and stored in the messaging center. For example, the message could be an SMS sent based on standard (current) GSM specifications from another mobile station in the telecommunication network, belonging to a first subscriber A. The SMS is routed to the Messaging Center defined in the A-subscribers handset/SIM. In this case the Messaging Center is dedicated to datacast messaging, i.e. a DMC (Datacast Messaging Center).

Thereafter, in step S2, the DMC locates the location of the mobile station to receive the message, i.e. subscriber B. This could be done by making a location register (HLR) query to check the subscriber location area (cell-id level). Further, the availability of the broadcast network is controlled for the located area, and it is decided whether datacast messaging could be used or not, step S3. In case the broadcast network is not available, e.g. if the subscriber is roaming when being abroad, or located outside the DVB-T Datacast service area, the SMS is forwarded to a standard SMSC or MMSC, step S4.

However, if it is decided in step S3 that the broadcast network is available, identification information is added to the message in order to form a broadcast message, step S5. Based on the location information of the recipient, the DMC links the transmission to the right area DVB-T Datacast carousel server.

The message is then included into the DVB-T datacast signal, step S6. To this end, the DMC put the message into the message queue and forwards the same message to a DVB-T Datacast carousel server within a DVB-T Datacast Service System. The message is then broadcasted in the defined DVB-T service area, step S7. The defined area may be a specific limited region, or could be even a whole country, due to the high capacity of DVB-T Datacast.

At the receiver side, the B-subscriber handset filters the right message from the DVB-T Datacast signal based on identification. When a message is received in the mobile station, an acknowledgement is sent back to the message center. This is preferably done over the telecommunication network, in the same fashion as in ordinary SMS messaging.

Preferably, the message is broadcast until a predetermined condition is met. Such a condition may e.g. be reception of an acknowledgement from the mobile station. In that case, the DMC awaits reception of the acknowledgement, and decides, preferably periodically, whether the acknowledgement has been received or not, step S8. In case no acknowledgement has been received, the transmission is repeated, i.e. the process returns to step S7. When the acknowledgement is received, the DMC deletes the message from the message queue and informs the DVB-T Datacast Carousel Server, which then deletes the message from the data stream to stop the broadcast of the message.

Other types of predetermined conditions may however be used in addition or as an alternative. For example, the messaging center may cancel the message after a certain time period, e.g. a minute. Thereafter, the message may be put it into a queue to be broadcast again later, like in current SMSC solutions.

The invention does not require any changes in the way of sending an SMS from a mobile to Messaging Center. The main modifications at the network side will be needed for the forwarding of the message, at the Messaging Center (either SMSC, MMSC or DMC) and HLR.

In the above-discussed embodiments, the HLR could use standard GSM security and specifications. Also there is a need to include the location information, such as cell id, into the DMC-HLR query.

If the functionality of the invention is implemented as a feature in the SMSC or MMSC, the main difference compared to currently used solutions is that the SMSC or MMSC should be capable to forward the messages to a broadcast network, such as a DVB-T Datacast carousel server. That could be implemented through the application interfaces available in the SMSCs or MMSCs already today, such as the CIMD interface in the Nokia SMSC. This type of implementation has the advantages of a relatively low cost. Some SMSCs, such as the Nokia SMS Center, can already be used for IP Backbone message delivery, which implies that the DMC feature could be implemented quite easily to the system. The MMSC systems are using IP connections already, so the feature could be added also into those quite easily.

The DMC may be an external API for messaging. If a separated DMC is implemented, some of the messages should preferably be forwarded to the standard SMSC or MMSC, e.g. for roaming customers. Such a connection could be implemented through an SMSC or MMSC application interface. This type of implementation has the advantages of a good capacity, redundancy and scalability.

The higher available capacity and network signaling efficiency reached by this invention enables also new richer content messages, like MMS type of messages. Further, this way of sending messages may be used in connection between club members (communities) where one of the member can send to his friends e.g. video clip or the like of a game. The message is sent to the DMC where all recipient addresses are checked and the data is sent to those recipients' addresses in their locations via the datacast system.

The data message size sent from the mobile terminal is preferably checked and if the size is recognized to be over a predetermined size limit, the message is stored in the server and a new transmission path is selected.

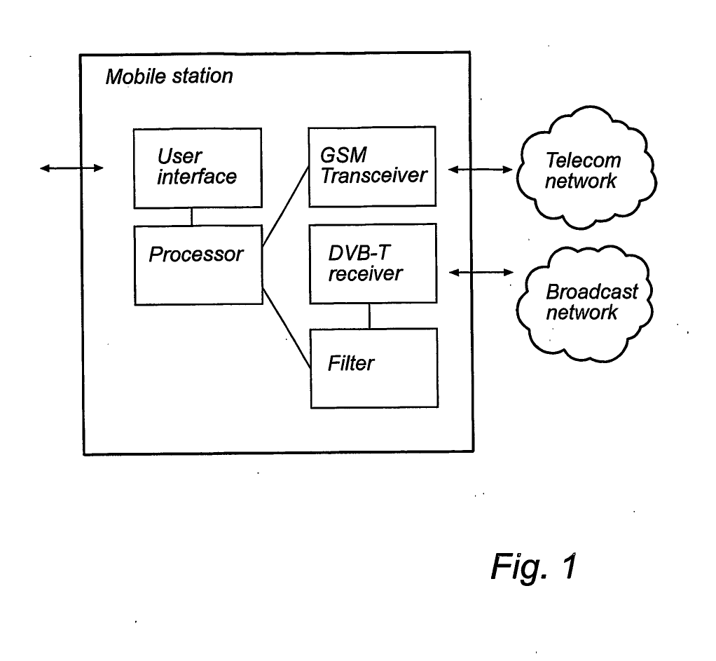

A mobile station, such as a mobile phone, to be used in the system and method discussed above, and as disclosed schematically in FIG. 1, comprises a bi-directional communication means for communication through said telecommunication network, i.e. an interface towards the telecommunication network, such as a GSM transceiver, a processor for processing of the received signals, and a user interface, such as a microphone and a speaker. Further, the mobile station comprises broadcast receiving means for receiving broadcasting information, i.e. a broadcast interface towards the broadcast network. As discussed above, the broadcast interface could e.g. comprise a DVB-T receiver.

The mobile station should also comprise filtering means for identifying if a data message received by said broadcast receiving means is intended for the receiving mobile station. As discussed above, this is done by analyzing the identification information in the received message. In case a message is correctly received, and acknowledgement could be sent back through the telecommunication network interface. This acknowledgement functionality from the receiving mobile towards the network is preferably the same as in current SMS implementations.

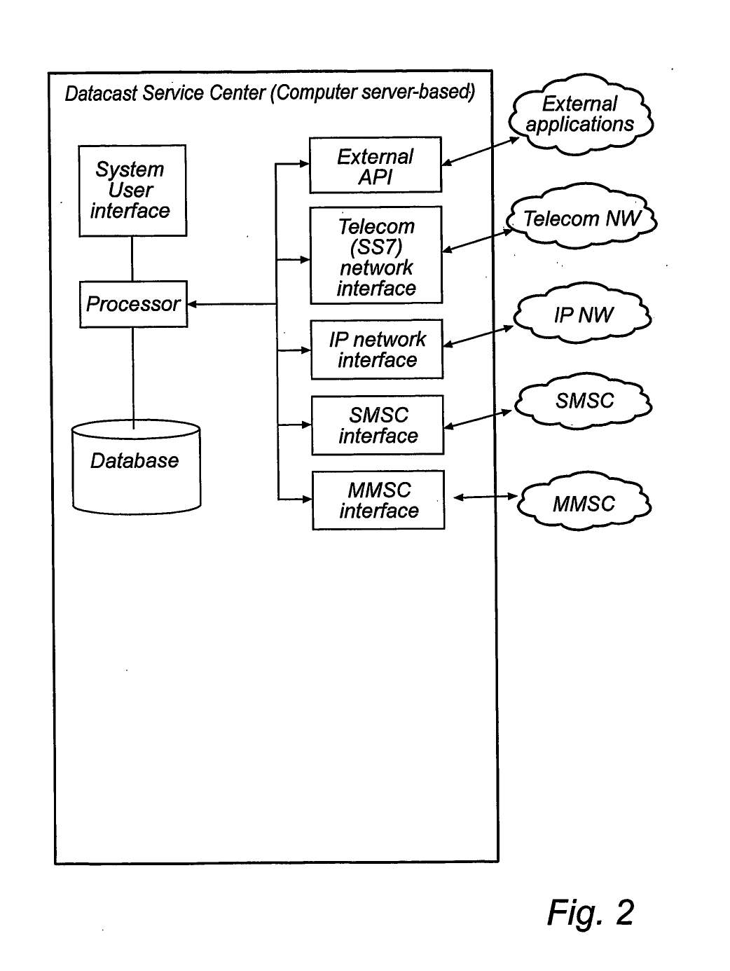

A datacast service center to be used in the system and method discussed above, and as disclosed schematically in FIG. 2, could preferably be computer server based, and comprises at least some, and preferably all, of the following modules and components:

A system user interface to enable user interaction;

A processor;

A database;

An external API, connected to the processor and providing an interface to an external application;

A telecom (SS7) network interface, connected to the processor and providing an interface to a telecom network;

An IP network interface, connected to the processor and providing an interface to an IP network;

A SMSC interface, connected to the processor and providing an interface to a SMSC; and

A MMSC interface, connected to the processor and providing an interface to a MMSC.

The above-discussed embodiments primarily relates to messaging over a DVB-T Datacast network with a dedicated DMC. However, it should be appreciated by those versed in the art that many alternatives would be possible as well, such as using other broadcast networks and standards, using a broadcast network where the DMC functionality is integrated in the SMC or MMSC of the telecommunication network or is provided in any other suitable manner. Further, different types of mobile stations could be used, the message center could be implemented in various ways, etc. Such and other closely related alternatives and modifications of the above discussed embodiments must be considered to be within the scope of the present invention, as it is defined in the appended claims.

1. A method for transmissions of a data message from a message center to a receiving mobile station in a telecommunication network, said method comprising the steps of:
providing a data message to be forwarded to said receiving mobile station;
incorporating identification information for identification of said receiving mobile station in said data message;
storing the message in a server;
making a query to check the receiving mobile station location area and availability in the server;
broadcasting said data message in a geographical area in which said receiving mobile station is situated; and
acknowledging reception of the data message at the receiving mobile station to the message center through the telecommunication network.

2. The method of claim 1, wherein the data message is broadcasted through Digital Video Broadcasting-Terrestrial (DVB-T) datacast.

3. The method of claim 1, wherein further comprising checking the data message size sent from the mobile terminal and if the size is recognized to be over a predetermined size limit, storing the message in the server.

4. The method of claim 1, wherein the data message is a Short Message Service (SMS) message or other richer content message like Multimedia Message (MMS).

5. The method of claim 3, further comprising the step of receiving the data message to be forwarded as an SMS or other message from another remote terminal in said telecommunication network.

6. The method of claim 1, wherein the geographical area in which the receiving mobile station is situated is identified by means of a location register, e.g. Home Location Register (HLR) of said telecommunication network.

7. The method of claim 1, wherein the identification information incorporated into the data message comprises a Mobile Subscriber ISDN number (MSISDN) or as a unique IP-address.

8. The method of claim 1, wherein the step of broadcasting said data message is repeated until a predetermined condition is reached.

9. The method of claim 8, wherein the predetermined condition is at least one of: reception of the acknowledgement from the receiving mobile station and reaching a predetermined maximum resending time.

10. An apparatus for transmission of a data message from a message center to a receiving mobile station in a telecommunication network, said apparatus comprising:
receiving means for reception of a data message to be forwarded to said receiving mobile station;
means for incorporating identification information for said receiving mobile station to said data message;
a broadcasting device for broadcasting said data message in a geographical area in which said receiving mobile station is situated; and
acknowledging reception means for reception of an acknowledgement from the receiving mobile station through the telecommunication network.

11. The apparatus of claim 10, wherein the broadcasting device is adapted for broadcasting through Digital Video Broadcasting-Terrestrial (DVB-T) datacast.

12. The apparatus of claim 10, wherein the receiving means is adapted for reception of Short Message Service (SMS) messages, Multimedia Messages or the like.

13. The apparatus of claim 10, further being connected to a location register, e.g. Home Location Register (HLR) of said telecommunication network for identification of the geographical area in which the receiving mobile station is situated.

14. The apparatus of claim 10, wherein the identification information incorporated into the data message comprises a Mobile Subscriber ISDN number (MSISDN) or a unique IP-address.

15. A mobile station for a telecommunication network, comprising:
bi-directional communication means for communication through said telecommunication network;
broadcast receiving means for receiving broadcasting information;
filtering means for identifying a receiving a data message received by said broadcast receiving means if said message comprises identification information for said receiving mobile station; and
means for acknowledging reception of a data message through said bi-directional communication means.

16. A telecommunications system comprising a telecommunication network and an apparatus for transmission of a data message from a message center to a receiving mobile station in the network according to claim 10.
